(19) United States
(12) Patent Application Publication
(10) Pub. No.: US 2003/0139514 A1
(43) Pub. Date: Jul. 24, 2003

(54) Agglomeratable rubber latex

(76) Inventor: Allen R. Padwa, Worcester, MA (US)

Correspondence Address: BAYER POLYMERS LLC, 100 BAYER ROAD, PITTSBURGH, PA, 15205, US

(21) Appl. No.: 10/052,611

(22) Filed: Jan. 18, 2002

(51) Int. Cl. C08K 3/20

(52) U.S. Cl. 524/457

(57) ABSTRACT

A method for making readily agglomeratable rubber latex is disclosed. The method that comprise emulsion polymerization of suitable monomers in the presence of an alkalipersulfate initiator and the optional presence of salt is based on the finding of the critical relationship between the amount of decomposed alkalipersulfate (W) and the particle size of the pre-agglomerated rubber particles (Dₒ). Accordingly, the relevant parameters relate as

K=W*(1-1.4S)*Dₒ

wherein S is the amount of the optional salt and K is a constant of 2.3-6.0. The pre-agglomerated rubber particles thus produced are agglomerated to a size of at least 1.5Dₒ by the mixing therewith of an agglomerating agent.

### FIELD OF THE INVENTION

The invention relates to emulsion polymerization of monomers to make rubber latex and more particularly to the preparation of readily agglomeratable rubber particles.

### SUMMARY OF THE INVENTION

A method for making readily agglomeratable rubber latex is disclosed. The emulsion polymerization of suitable monomers in the presence of an alkalipersulfate initiator and the optional presence of salt are known. The invention is based on the finding of the critical relationship between the amount of decomposed alkalipersulfate (W) and the particle size of the pre-agglomerated rubber particles (Dₒ). Accordingly, the relevant parameters relate as

K=W*(1-1.4S)*Dₒ

wherein S is the amount of the optional salt and K is a constant of 2.3-6.0. The pre-agglomerated rubber particles thus produced are agglomerated to a size of at least 1.5Dₒ by the mixing therewith of an agglomerating agent.

### BACKGROUND OF THE INVENTION

Rubber latices have long been used in the manufacture of rubber reinforced plastics such as (acrylonitrile-butadiene-styrene) ABS resins. It is well known that the properties of the reinforced plastics, most notably their mechanical properties and especially impact strength are critically dependent on the size of the rubber particles. The control of particle size in the context of emulsion polymerization is therefore of interest.

The polymerization processes typically make use of an initiator, such as persulfate. The resulting latex is characterized by the relatively small particle size that do not agglomerate well.

The art includes disclosures relative to chemical agglomeration for the production of large rubber particles from small rubber particles. Facilitating agglomeration has been reported to be attained by the addition of water-soluble organic acids or organic anhydrides. U.S. Pat. No. 3,558,541 disclosed an agglomeration process whereby an acid anhydride is admixed with an aqueous latex of a polymer that contains an organic acid salt emulsifying agent and the admixture permitted to stand for a period of time sufficient to hydrolize the acid anhydride and produce agglomeration of the polymer particles. U.S. Pat. No. 5,468,788 disclosed a process for agglomerating small rubber particles involving the addition of a water-soluble organic acid and water-soluble organic anhydride to the latex prior to agglomeration. The resulting particles are said to be essentially free of coagulum.

The present invention is predicated on the surprising finding of the critical dependence of the capacity of the polymerized rubber to agglomerate on the amount of initiator.

### DETAILED DESCRIPTION OF THE INVENTION

The polymerization of suitable monomers to form latex is known. It is carried out in the presence of an alkalipersulfate initiator and the optional presence of salt. The capacity of the polymerized rubber to agglomerate was found to be profoundly dependant on the conditions of the synthesis of the latex.

The inventive process that yields readily agglomeratable rubber particles that are substantially free of coagulum comprise emulsion polymerization of suitable monomers in the presence of an alkalipersulfate initiator and the optional presence of salt. The invention is based on the finding of the critical relationship between the amount of decomposed alkalipersulfate (W) and the particle size of the pre-agglomerated rubber particles (Dₒ). Accordingly, the relevant parameters relate as

K=W*(1-1.4S)*Dₒ

wherein S is the amount of the optional salt and K is a constant of 2.3-6.0.

The pre-agglomerated rubber particles thus produced are agglomerated to a size of at least 1.5Dₒ by the mixing therewith of an agglomerating agent.

In the expression above

W denotes the amount, in parts per one hundred parts by weight (pphr) of latex solids, of decomposed alkalipersulfate,

Dₒ refers to the weight average particle size, in nanometers (nm), of the pre-agglomerated (un-agglomerated) rubber, with the proviso that

Dₒ is at least 85 nm, preferably at least 100 nm,

S is the amount of the optional salt (in % based on latex solids) and,

K is a constant of 2.3-6.0, preferably 3-4, most preferably 3.25-3.50.

The resulting rubber particles having particle size Dₒ are agglomerated to form particles having size D wherein D/Dₒ is at least 1.5 by mixing an agglomerating agent, preferably an organic acid anhydride, therewith.

The monomers suitable in the process of the present invention are selected from among 1,3-dienes and (meth)acrylates. Both homopolymers and copolymers are suitable. The suitable comonomers include monvinylidene aromatic hydrocarbons (e.g., styrene; an alkylstyrene, such as the o-, m-, and p-methylstyrene, 2,4-dimethylstyrene, ethylstyrene, p-tert-butylstyrene;) and alpha-alkylstyrene, such as alpha-methylstyrene, alpha-ethylstyrene, alpha-methyl-n-methylstyrene; vinyl naphthalene; acrylonitrile; methacrylonitrile; alkyl (meth)acrylates (e.g., methyl (meth)acrylate, butyl (meth)acrylate, 2-ethylhexyl (meth)acrylate) and acrylamides (e.g., acrylamide, methacrylamide, N-butyl acrylamide). Preferably the process entails the polymerization of monomer systems containing 75 to 100 percent by weight of butadiene and/or isoprene and up to 25 percent by weight of at least one member selected from the group consisting of monovinylidene aromatic hydrocarbons (e.g., styrene) and unsaturated nitriles (e.g., acrylonitrile). Particularly advantageous systems contain 1,3-butadiene or a mixture of 80 to 95 percent by weight butadiene and 5 to 20 percent by weight of acrylonitrile and/or styrene.

The polymerized rubber may be crosslinked. Crosslinking such as by the inclusion of up to about 2 percent by weight-based on the weight of the rubber-forming monomer or monomers- of a cross-linking agent is attained by procedures and agents that are well known in the art. Suitable cross-linking agents include divinylbenzene, diallyl maleate, diallyl fumarate, diallyl adipate, allyl acrylate, allylmethacrylate, diacrylates and dimethacrylates of polyhydric alcohols, e.g., ethylene glycol dimethacrylate.

The small rubber particles are prepared by emulsion polymerization. As is well known in the art of emulsion polymerization, the procedure entails polymerizing monomers in a mixture that contains water, emulsifying agent, optional salt, optional chain transfer agent and an initiator in relative amounts such that the solids content of the resulting latex is 20 to 70% by weight, preferably 30 to 60% and most preferably 40 to 50%. As is well known, the polymerization may also be carried out by using seed in the form of latex of small particle size, typically particles having a diameter of ½ or less of the desired particle size of the resulting latex. The compositional makeup of the seed is independent of that of the polymerized rubber. For example, a polybutadiene latex polymerization may be seeded by poly(butadiene-co-styrene) or polybutadiene seed latex.

Suitable emulsifying agents include organic carboxylic acid salts. These include alkali salts of fatty acids (in particular lauric acid, oleic acid, steric acid, palmitic acid, and their mixtures) and derivatives of rosin acids. Minor amounts of acid-stable anionic surfactants, such as alkyl or alkaryl sulfates, sulfonates, phosphates and mixtures thereof, may be added in small amounts as their presence affects the agglomeration behavior of the latex. Preferably no acid-stable anionic surfactants are used. Generally, the emulsifying agent is used in an amount of about 0.05 to 15 parts, preferably 0.1 to 5 parts, per 100 parts of latex solids.

Optional salts include alkali salts such as alkali halides, nitrates, sulfates, phosphates, pyrophosphates, preferably sodium sulfate, sodium chloride or potassium chloride. The amount of the salt is 0 to 0.6 percent relative to the latex solids.

It is often desirable to include chain transfer agents. These agents include mercaptans, halides, or terpenes. The preferred chain transfer agents are alkyl mercaptans at a concentration of 0.01 to 2.0% based on latex solids.

The polymerization is initiated by alkali persulfates although other free-radical polymerization initiators may additionally be used, including actinic radiation, azo initiators and organic peroxides which may be activated to form a redox system. Preferred initiators are alkali persulfates, such as sodium or potassium persulfates.

The amount of persulfate decomposed during the polymerization (W) is determined as the difference between the total amount of persulfate added and the amount of residual persulfate in the latex at the end of polymerization, e.g., by iodometric titration, or by calculation.

The resulting small rubber particles having particle size Dₒ are agglomerated by admixing therewith an agglomerating agent. Suitable agglomerating agents include organic acid anhydrides and an optional aqueous solution of an organic acid.

As has been indicated, a latex having a weight average particle size, Dₒ, of 0.085 to 0.20 microns may be agglomerated to preferably provide a weight average particle size diameter, D, of 0.125 to 1.2 microns. Preferably, the initial latex has small rubber particles having a weight average particle size diameter, Dₒ, of 0.085 to 0.13 microns which are agglomerated to form a latex containing large rubber particles having a weight average particle size diameter, D, of 0.30 to 0.60 microns, and preferably at least 0.4 microns.

In the preferred agglomeration process, an aqueous solution of an organic acid anhydride is added to the rubber latex thus prepared and dispersed therein.

Organic acid anhydrides are suitable as agglomerating agents in the present context and include such acid anhydrides that are water soluble to an extent sufficient to hydrolyze and provide acid radicals for reaction with the emulsifying agent to reduce the stability of the latex and allow particle agglomeration. Typical acid anhydrides are acetic acid anhydride, maleic acid anhydride, and propionic acid anhydride and the like. Water soluble organic acid may also be added in the agglomeration step. These acids include acetic acid, maleic acid, propionic acid, acrylic acid and oxalic acid. Generally, the amount of agglomerating agent employed will vary with the electrolyte and emulsifying agent present in the latex, the desired size of large rubber particles to be obtained and will be at least one-tenth the molar equivalent of the emulsifying agent. Normally, the amount employed is at least one-fourth the molar equivalent and preferably the amount added is in excess of the molar amount of the emulsifying agent.

The latex is briefly mixed with the agglomerating agent and then allowed to stand undisturbed until the organic anhydride hydrolysis deactivates the emulsifying agent and causes agglomeration of the rubbery particles. Substantial shear agitation during this stage of the process is to be avoided to prevent coagulation. The agglomeration may be carried out in either a batch or continuous fashion. After the agglomeration has been completed, the latex may be stabilized by the addition of a base or a surfactant.

The time for agglomeration will vary with temperature, the amount of agglomerating and emulsifying agent, the nature of the rubbery polymer, the amount of the initial and desired sizes of the particles. Periods of five minutes to ten hours may be employed; typically, times of about five minutes to two hours may be employed at ambient temperatures.

After the agglomeration has been completed, the latex may be stabilized by adding an acid-stable emulsifier or by the regeneration of the initial soap emulsifier by the addition of a basic compound to neutralize the acid. Suitable emulsifiers include anionic agents such as alkali metal salts of long chain sulfonic acids. An alkali metal hydroxide or other basic compound such as carbonate may be added to regenerate the carboxylic acid soap; the amount added will normally be the stoichiometric equivalent of the agglomerating agent although lesser amounts may be employed with some lessening in stability of the latex.

A stable emulsion suitable for subsequent processing includes the particles colloidally dispersed in the latex having a pH value of 8.0 to 13.0, preferably 9.0 to 11.0.

The invention is further illustrated but is not intended to be limited by the following examples in which all parts and percentages are by weight unless otherwise specified.

### EXAMPLES

Experimental

1. A seed polybutadiene latex of about 50 nm particle size was charged to an autoclave containing Na₂SO₄ (see explanation below), 1 mole of KOH per mole of persulfate to be used in the polymerization and dilution water to result in latex containing 42% solids. The autoclave was purged with nitrogen during heating to 75° C. 10% of the total monomer (or mixture of monomers) and 10% of the chain transfer agent were first charged. The addition of a 0.02 pphm (part per one hundred monomer) of potassium persulfate marked the beginning of the polymerization cycle. The remaining persulfate was linearly metered over 840 minutes. At 45 minutes, the remaining monomers and chain transfer agent were linearly metered until 465 minutes. 1.0 pphm of Dresinate 731A soap (Hercules Inc, rosin acid) were metered from 90 to 780 minutes. At about 570 minutes, the initial batch pressure of about 140 psi decreased to about 130 psi. The temperature was than raised over a period of 45 minutes to 85° C. The batch was cooled at about 950 minutes concurrent with the pressure decrease to 50 psi. The resulting Dₒ values are shown in the table as examples 4-8.

2. The procedure described above was used except that the amount of seed latex was increased, following the usual seeded-latex calculation rules; the amount of Dresinate 731A soap was 1.5 pphm. All the potassium persulfate was added at the start of the polymerization cycle. The monomers were metered from 45 to 240 minutes and the soap was metered from 90 to 330 minutes. The batch was cooled at 360 minutes.

For experiment #3, the polymerization was started at 60° C. Monomer and soap feeding rates were adjusted to complete the polymerization in 30 hours. After the pressure break, the batch was heated to 65° C. until pressure of 50 psi was achieved. The Dₒ values are reported in Examples 1-3.

The agglomeration of the resulting latices was carried out as follows:

To 100 grams of rapidly stirring latex, there was added rapidly a freshly prepared solution of 0.4 ml of Acetic Anhydride dissolved in 10 ml of Water. Stirring was continued for 30 seconds and then stopped and the system allowed to rest undisturbed for 30 minutes. Then 10 ml of a 10% aqueous solution of sodium dodecyidiphenylether disulfonate (Calfax®) surfactant was added slowly, followed by mild agitation.

The table below summarizes the results of several experiments demonstrating the invention. Essentially, these experiments show the effect of the amount of potassium persulfate initiator (herein KPS) on the agglomeration behavior of latex.

All the experiments, except example 3 that contained no salt, contained 0.5 pphm of Na₂SO₄. Example 4 is a comparative example. The particle size was measured on a BI-90 photon correlation spectrometer manufactured by Brookhaven Instruments Corp., Holtsville, N.Y.

TABLE 1

| | | | KPS | | | |
|---|---|---|---|---|---|---|
| | Rubber | Do | charged | D | | |
| Example | type⁽¹⁾ | (nm) | (pphm) | (nm) | D/Do | K |
| 1 | BD/Sty | 129 | 0.15 | 296 | 2.3 | 5.8 |
| 2 (comp)⁽³⁾ | BD/Sty | 132 | 0.05 | 1654 | 12.7 | 2.0 |
| 3⁽²⁾ | BD | 130 | 0.12 | 450 | 3.5 | 2.7 |
| 4 (comp) | BD/Sty | 193 | 0.3 | 180 | 0.9 | 17.4 |
| 5 | BD/Sty | 191 | 0.1 | 300 | 1.6 | 5.7 |
| 6 | BD/Sty | 190 | 0.07 | 580 | 3.1 | 4.0 |
| 7 | BD/Sty | 182 | 0.06 | 620 | 3.4 | 3.3 |
| 8 | BD | 208 | 0.07 | 700 | 3.4 | 4.4 |

⁽¹⁾BD denoted butadiene, Sty denotes styrene. BD/Sty denotes 90 wt. % butadiene/10 wt. % styrene); In all instances the monomers contained 0.6 wt. % of t-dodecyl mercaptan) chain transfer agent.
⁽²⁾In the preparation of Example 3, KPS in an amount of 0.12 pphm was charged but 0.021 pphm were decomposed. In the remaining examples, all the KPS was decomposed.
⁽³⁾Except for Example 2, the agglomerated latices of the examples above included virtually no coagulum, that is less than 0.2%, relative to the weight of the latex solids. The latex of Example 2 contained coagulum in an amount greater than 5%.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. In the process of polymerizing a material system containing an emulsion of at least one monomer for making a rubber latex in the presence of a alkalipersulfate initiator and the optional presence of salt, the improvement comprising using said initiator in an amount wherein W, the quantity, in pphr, of decomposed alkalipersulfate relates to the particle size, in nanometers, of the pre-agglomerated rubber particles (Dₒ) as
K=W*(1-1.4S)*Dₒ
wherein S is the amount, in percent relative to the weight of solids in the rubber latex, of the optional salt and K is a constant of 2.3-6.0, with the proviso that Do is at least 85 nm.

2. The process of claim 1 wherein K is 3-4.

3. The process of claim 1 wherein K is 3.25-3.50.

4. The process of claim 1 wherein Dₒ is at least 100 nm.

5. The process of claim 1 wherein monomer is at least one member selected from the group consisting of 1,3-dienes and (meth)acrylates.

6. The process of claim 5 wherein monomers further include at least one member selected from the group consisting of styrene, alkylstyrene, vinyl naphthalene; (meth)acrylonitrile and acrylamide.

7. The process of claim 1 wherein the material systems contains 75 to 100 percent by weight of butadiene and/or isoprene and up to 25 percent by weight of at least one member selected from the group consisting of monovinylidene aromatic hydrocarbons and unsaturated nitrites.

8. The process of claim 1 wherein the material system contains 1,3-butadiene.

9. The process of claim 1 wherein the material system is a mixture of 80 to 95 percent by weight of butadiene and 5 to 20 percent by weight of acrylonitrile and/or styrene.

10. In the process of polymerizing a material system containing an emulsion of at least one monomer selected from the group consisting of 1,3-dienes and (meth)acrylates. and a crosslinking agent, for making a rubber latex in the presence of a alkalipersulfate initiator and the optional presence of salt, the improvement comprising using said initiator in an amount wherein W, the quantity, in pphr, of decomposed alkalipersulfate relates to the particle size, in nanometers, of the pre-agglomerated rubber particles (Dₒ) as
K=W*(1-1.4S)*Dₒ
wherein S is the amount, in percent relative to the weight of solids in the rubber latex, of the optional salt and K is a constant of 3-4.0, with the proviso that Dₒ is at least 100 nm.

11. The process of claim 1 wherein emulsion further contains a cross linking agent.

12. The process of claim 11 wherein crosslinking agent is a member selected from the group consisting of divinylbenzene, diallyl maleate, diallyl fumarate, diallyl adipate, allyl acrylate, allylmethacrylate, diacrylates and dimethacrylates of polyhydric alcohols.

13. A process for making an agglomerate of rubber latex having agglomerate particle size, D, measured in nanometers, comprising
(i) polymerizing a material system containing an emulsion of at least one monomer for making a rubber latex in the presence of a alkalipersulfate initiator and the optional presence of salt, to obtain latex having pre-agglomerated particle size, in nanometers, Dₒ,
(ii) mixing the latex obtained in (i) with an agglomerating agent, wherein the quantity, in pphr, of decomposed alkalipersulfate, W, relates to Dₒ as
K=W*(1-1.4S)*Dₒ
where S is the amount, in percent relative to the weight of solids in the rubber latex, of the optional salt and K is a constant of 2.3-6.0, with the proviso that is Dₒ at least 85 nm and D/Dₒ is at least 1.5.

14. The process of claim 13 wherein K is 3-4.

15. The process of claim 13 wherein K is 3.25-3.50.

16. The process of claim 13 wherein Dₒ is at least 100 nm.

17. The process of claim 13 wherein monomer is at least one member selected from the group consisting of 1,3-dienes and (meth)acrylates.

18. The process of claim 17 wherein monomers further include at least one member selected from the group consisting of styrene, alkylstyrene, vinyl naphthalene; (meth)acrylonitrile and acrylamide.

19. The process of claim 13 wherein the material systems contains 75 to 100 percent by weight of butadiene and/or isoprene and up to 25 percent by weight of at least one member selected from the group consisting of monovinylidene aromatic hydrocarbons and unsaturated nitrites.

20. The process of claim 13 wherein the material system contains 1,3-butadiene.

21. The process of claim 13 wherein the material system is a mixture of 80 to 95 percent by weight of butadiene and 5 to 20 percent by weight of acrylonitrile and/or styrene.

22. The process of claim 13 wherein agglomerating agent is an organic acid anhydride.

23. The process of claim 22 wherein agent further contains an aqueous solution of an organic acid.

24. The process of claim 13 wherein emulsion further contains a cross linking agent.

25. The process of claim 24 wherein crosslinking agent is a member selected from the group consisting of divinylbenzene, diallyl maleate, diallyl fumarate, diallyl adipate, allyl acrylate, allylmethacrylate, diacrylates and dimethacrylates of polyhydric alcohols.

26. The polymerized material system prepared by the process of claim 1.

27. The agglomerate of rubber latex prepared by the process of claim 3.
